(19) United States
(12) Patent Application Publication
(10) Pub. No.: US 2002/0109369 A1
(43) Pub. Date: Aug. 15, 2002

(54) Hideaway tailgate seat

(76) Inventors: John Boomhower, Bedford (CA); Clinton Garz, Bedford (CA)

Correspondence Address: OGILVY RENAULT, 1981 MCGILL COLLEGE AVENUE, SUITE 1600, MONTREAL, QC, H3A2Y3, CA

(21) Appl. No.: 09/782,076

(22) Filed: Feb. 14, 2001

(51) Int. Cl. B60N 2/00

(52) U.S. Cl. 296/63; 296/57.1

(57) ABSTRACT

A pick-up truck tailgate comprises a rigid body housing a foldable seat. The seat is exposed by first lowering the tailgate and then opening the tailgate body. By integrating the seat directly into the tailgate body, it is possible to maintain full pickup box cargo volume.

### BACKGROUND OF THE INVENTION

1. Field of the Invention

The present invention relates to tailgates and, more particularly, to a new tailgate adapted to be converted into a seat.

2. Description of the Prior Art

Over the years, various seat structures have been developed for mounting on tailgates of vehicles, such as pick-up trucks and sport utility vehicles. For instance, U.S. Pat. No. 5,971,464 issued on Oct. 26, 1999 to Davis et al. teaches to add a pivotable protective pick-up truck tailgate liner assembly to an existing tailgate. The tailgate liner assembly is pivotally mounted to a cab facing surface of the existing tailgate so as to form a tailgate seat-back rest when pivoted away from the tailgate to an open position thereof. When closed, it serves as a protective tailgate liner.

Although the tailgate liner assembly described in the above-mentioned patent is effective, it has been found that there is a need for a new tailgate seat arrangement wherein the seat is normally not exposed to the elements and wherein the payload volume of the cargo box of the vehicle is not reduced as a result of the presence of the tailgate seat.

### SUMMARY OF THE INVENTION

It is therefore an aim of the present invention to provide a new tailgate having a seat incorporated therein.

It is also an aim of the present invention to provide a tailgate seat without interfering with the load capacity of the cargo box to which is mounted the tailgate.

It is a further aim of the present invention, to provide a new seat tailgate construction which is relatively simple and economical to manufacture.

Therefore, in accordance with the present invention, there is provided a tailgate adapted to be mounted at a rear end of a cargo box of a vehicle for movement between a raised position for closing the rear end of the cargo box and a lowered position for loading and unloading of the cargo box. The tailgate comprises a tailgate body having predetermined dimensions and a foldable seat integrated within the tailgate body and movable between a seat hidden position and a seat displayed position, whereby when said seat is in a seat hidden position it is within said predetermined dimensions of the tailgate. The foldable seat has a seat portion and a backrest portion upon which at least one person can rest when the tailgate has been displaced to the lowered position thereof and the foldable seat has been displayed.

In accordance with a further general aspect of the present invention, there is provided a tailgate for a cargo box of a vehicle, comprising a tailgate body displaceable between raised and lowered positions to facilitate loading and unloading of the cargo box, and a foldable seat concealed within said tailgate body. The tailgate body has a weatherproof cover displaceable from a closed position to an open position for allowing the foldable seat to be exposed.

### BRIEF DESCRIPTION OF THE DRAWINGS

Having thus generally described the nature of the invention, reference will now be made to the accompanying drawings, showing by way of illustration a preferred embodiment thereof, and in which:

FIG. 1 is a perspective view of a tailgate having a seat integrated therein in accordance with a first embodiment of the present invention; and

FIG. 2 is side elevational view of the tailgate of FIG. 1.

### DESCRIPTION OF THE PREFERRED EMBODIMENTS

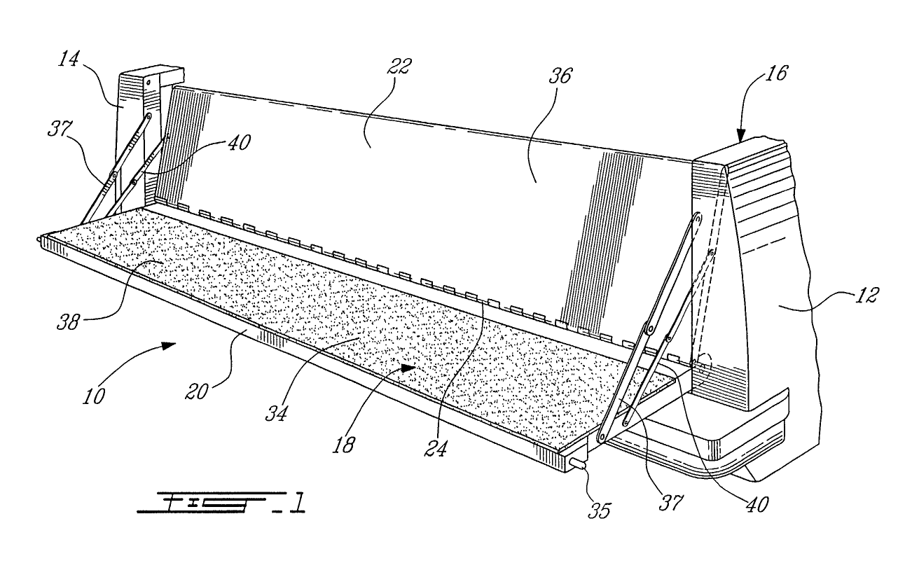

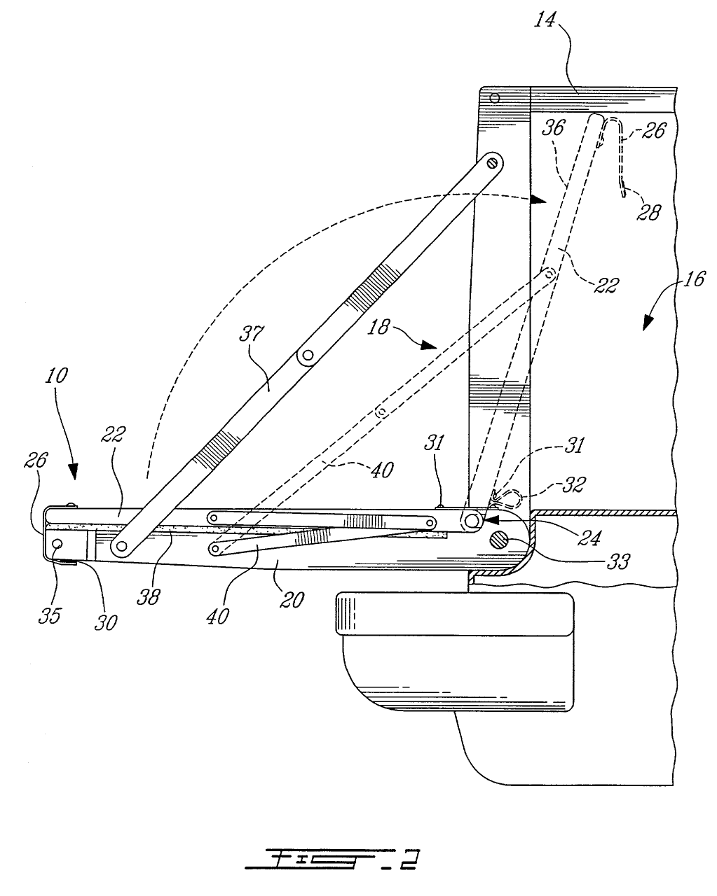

FIGS. 1 and 2 illustrate a tailgate 10 pivotally mounted at a lower end thereof to the side walls 12 and 14 of a cargo box 16 of a vehicle, such as a pick-up truck. The tailgate 10 is pivotable between a raised position for closing the rear end of the cargo box 16 and a lowered position for loading and unloading of the cargo box 16.

As seen in FIG. 2, once the tailgate 10 has been displaced to its lowered horizontal position, the tailgate itself can be opened to expose a seat 18 otherwise concealed within the tailgate body.

The tailgate body includes first and second stamped metal panels 20 and 22. A slotted hinge 24 is provided along the lower ends of the first and second panels 20 and 22 for pivotally connecting the panels together. The first and second panels 20 and 22 are pivotable relative to one another between a closed position wherein the panels 20 and 22 are folded one against the other (see FIG. 2) and an open position wherein the panels 20 and 22 extend at an obtuse angle with respect to each other. A weatherproof cover in the form of a closure flap 26 (FIG. 2) is provided for releasably holding the first and second panels 20 and 22 in their closed position and protect the seat 18 from the elements when the panels 20 and 22 are retained in the closed position thereof to be used as a tailgate. The closure flap 26 is secured along one end thereof to an upper end of the second panel 22 and is adapted to be folded over against an outer surface of the first panel 20. The closure flap 26 is provided on an undersurface thereof with a snap fit connector 28 for engagement with a corresponding snap fit connector 30 provided on an outer surface of the first panel 20. By engaging the snap fit connectors 28 and 30 together, the first and second panels 20 and 22 are releasably retained together for joint movement as a unit relative to the cargo box 16. It is understood that other types of quick connectors, such as Velcro™ bands, could be used to releasably retained the first and second panels 20 and 22 in parallel relationship. The tailgate body further includes an elongated flexible weatherproof membrane 32 for preventing foreign matters from entering between the panels 20 and 22 adjacent the pivot point thereof. Anchors 31 are provided at regular intervals along the lower ends of the first and second panels 20 and 22 for securing the flexible weatherproof membrane 32 to the outer surfaces thereof, as seen in FIG. 2.

As can be appreciated, the closure flap 26 and the flexible weatherproof membrane 32 cooperate with the first and second panels 20 and 22 to conceal the seat 18 and protect it from the elements when the same is not being used. It is pointed out that the panels 20 and 22 could be provided with side walls to completely enclose the seat 10 within the tailgate 10 when the panels 20 and 22 are retained in the closed position thereof by the closure flap 28.

Pivot pins 33 extend laterally outwardly from either side of the lower end of the first panel 20 for allowing the above described tailgate body or assembly to be pivotally mounted to the cargo box 16, as well known in the art.

Striker pins 35 are provided on opposed sides of the first panel 20 for locking into corresponding latch brackets (not shown) when the first and second panels are secured together and pivoted to the raised position for closing the cargo box 16. A handle (not shown) operates the striker pins 35 to retract the same from the latch brackets when it is desired to pivot the tailgate 10 from its raised position to its lowered position.

A pair of foldable arms 37 extend between the side walls 12 and 14 of the cargo box 16 and the first panel 20 to limit the downward pivotal movement of the first panel 20 and support the tailgate 10 in its lowered position.

The seat 18 comprises a seat portion 34 and a backrest portion 36. The seat portion 34 and the backrest portion 36 are respectively provided by the inner facing surfaces of the first and second panels 20 and 22. The first and second panels 20 and 22 act as structural back panels for the seat portion 34 and the backrest portion 36, respectively, the outer surface of the panels 20 and 22 being the steel backing of the seat portion 34 and the backrest portion 36. The inner facing surface of the first panel 20 is covered with a foam padding 38 so as to provide any level of comfort and luxury desired. It is understood that the inner facing surface of the second panel 22 could also be provided with similar padding. However, such internal foam padding must not prevent the first and second panels 20 and 22 from being closed in a parallel relationship.

Foldable struts 40 extend between the first and second panels 20 and 22 to limit relative pivotal movement therebetween. Other means could be used as well to support the second panel in its open position, as illustrated in FIGS. 1 and 2. For instance, the second panel 22 could be provided on either side thereof with striker pins for engagement with latch brackets mounted to the side walls 12 and 14 of the cargo box 16.

One advantage of incorporating the tailgate seat in the tailgate itself, as described hereinbefore, is that the external appearance of the tailgate is not altered. Furthermore, the payload volume of the cargo box is preserved. A further advantage is that the tailgate seat is protect from the elements when not used.

To expose and unfold the seat 18 one simply pivots the tailgate 10 to its lowered position, releases the closure flap 26 from the first panel 20 and then rotates the second panel 22 upwardly to its open position, as illustrated in dotted lines in FIG. 2.

While the invention has been described with reference to one preferred embodiment, it is to be understood by those skilled in the art that the invention is not limited thereto.

1. A tailgate adapted to be mounted at a rear end of a cargo box of a vehicle for movement between a raised position for closing the rear end of the cargo box and a lowered position for providing access to the cargo box, comprising a tailgate body having predetermined dimensions, a foldable seat integrated within said tailgate body and movable between a seat hidden position and a seat displayed position, whereby when said seat is in a seat hidden position it is within said predetermined dimensions of the tailgate, said foldable seat having a seat portion and a backrest portion upon which at least one person can rest when the tailgate has been displaced to said lowered position thereof and the foldable seat has been displayed.

2. A tailgate as defined in claim 1, wherein said tailgate body comprises first and second interconnected panels displaceable relative to one another between an open position for exposing said seat and a closed position for concealing said seat within said tailgate body, and wherein a weatherproof cover is further provided for sealing said seat from the elements when said first and second panels assume said closed position thereof.

3. A tailgate as defined in claim 2, wherein said first and second panels are adapted to be pivotally mounted to the cargo box for movement as a single unit between said raised and lowered positions.

4. A tailgate as defined in claim 3, wherein said first panel is provided with hinge means for allowing said tailgate to be pivotally mounted to the cargo box, and wherein said second panel is pivotally connected to said first panel.

5. A tailgate as defined in claim 4, wherein said first panel is provided on either side thereof with latch means for releasably holding said tailgate in said raised position thereof.

6. A tailgate as defined in claim 2, wherein said weatherproof cover provides a lock for releasably holding said first and second panels in said closed position thereof.

7. A tailgate as defined in claim 6, wherein said weatherproof cover is connected to said second panel along an upper end thereof and is pivotable over said first panel for engagement with a cooperating locking member provided on said first panel.

8. A tailgate as defined in claim 7, wherein said weatherproof cover is provided in the form of a foldable closure flap.

9. A tailgate as defined in claim 2, wherein said first and second panels are provided with respective inner and outer facing surfaces, said outer facing surfaces forming part of the exterior surface of the tailgate, said inner facing surfaces being provided with padding to form said seat portion and said backrest portion.

10. A tailgate as define in claim 4, wherein a flexible weatherproof membrane is provided between said first and second panels adjacent a bottom pivot axis thereof.

11. A tailgate for a cargo box of a vehicle, comprising a tailgate body displaceable between raised and lowered positions to facilitate loading and unloading of the cargo box, and a foldable seat concealed within said tailgate body, said tailgate body having a weatherproof cover displaceable from a closed position to an open position for allowing said foldable seat to be exposed.

12. A tailgate as defined in claim 11, wherein said tailgate body includes first and second panels hinged to one another for movement between a closed position for allowing said tailgate body to be used as a closure for the cargo box and an open position in which said foldable seat is exposed and unfolded.

13. A tailgate as defined in claim 12, wherein said weatherproof cover is adapted to releasably hold said first and second panels in said closed position thereof.

14. A tailgate as defined in claim 13, wherein said weatherproof cover is mounted to said second panel and securable to said first panel.
